(19) United States
(12) Patent Application Publication
(10) Pub. No.: US 2016/0139803 A1
(43) Pub. Date: May 19, 2016

(54) REGIONAL ZOOMING VIRTUAL KEYBOARDS FOR ACCURATE TYPING ON SMALL DISPLAYS

(71) Applicant: City University of Hong Kong, Kowloon (HK)

(72) Inventor: Hong Yan, Kowloon (HK)

(21) Appl. No.: 14/239,098

(22) PCT Filed: May 17, 2013
(86) PCT No.: PCT/CN2013/075822

§ 371 Date: Feb. 14, 2014

(51) Int. Cl. G06F 3/0488; G06T 3/40

(52) U.S. Cl. CPC G06F 3/04886; G06T 3/40

(57) ABSTRACT

A virtual keyboard is generated that is capable of regional zooming to facilitate accurate typing on small displays. For instance, a system employs keyboard presentation component that generates a virtual keyboard for presentation by a user interface, wherein the virtual keyboard comprises an integer number of character keys. An association component associates at least one touch point of the user interface to a character key group comprising a character key and at least one neighboring character key that is adjacent to the character key. A magnifying component magnifies the character key group associated with the at least one touch point in response to touch activation of the at least one touch point. A corresponding component corresponds the at least one touch point as magnified to the character key as magnified. An input component receives input, via a text box of the user interface, wherein the input comprises a character assigned to the character key in response to touch activation of the character key as magnified.

### RELATED APPLICATION

The subject patent cooperative treaty (PCT) application claims priority to U.S. Provisional Appln. No. 61/776,745, filed Mar. 11, 2013, entitled “Region Zooming Virtual Keyboards for Accurate Typing on Small Displays”. The entirety of this provisional application is incorporated by reference herein to the extent permitted.

### TECHNICAL FIELD

The subject disclosure relates generally to generating a virtual keyboard, e.g., to systems, methods, and devices that employ a virtual keyboard capable of regional zooming to facilitate accurate typing on small displays.

### BACKGROUND

Virtual keyboards are often presented to a user on a small device display, such as a mobile phone. Many users find typing on a virtual keyboard presented on such a small display to be difficult. At times, the character keys are miniature in order to fit an entire set of alphanumeric characters that comprise a virtual keyboard on the device display. A user may unintentionally press a character key other than the intended character key due to the small size of each respective key or the close spacing between such individual keys. A user whom persistently mistypes one or more keys can be subject to time delays in sending messages or performing search queries. Additionally, with the advent of touch based user interfaces, a touch point on a screen may not match up with a particular intended character key exactly or touch points can be spaced so close together that a user is likely to mistype various character keys on small touch based display devices.

Furthermore, where an auto correct feature is applicable, the user may incur numerous auto-correction prompts with respect to misspelled or mistyped words whereby greater levels of user effort and inconvenience may be incurred. Also, as technology advances and devices become smaller as well as compact, the ability to facilitate user typing on smaller virtual keyboards is likely to remain of interest. The above-described examples are merely intended to provide an overview of some of the issues associated with user typing on a virtual keyboard presented on a small device display, and are not intended to be exhaustive. Other contextual information about conventional systems may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with facilitating virtual keyboard regional zooming for accurate typing on small displays. For instance, an embodiment includes a keyboard presentation component that generates a virtual keyboard for presentation by a user interface, wherein the virtual keyboard comprises an integer number of character keys, an association component that associates at least one touch point of the user interface to a character key group comprising a character key and at least one neighboring character key that is adjacent to the character key, a magnifying component that magnifies the character key group associated with the at least one touch point in response to touch activation of the at least one touch point, a corresponding component that corresponds the at least one touch point as magnified to the character key as magnified, and an input component that receives input, via a text box of the user interface, wherein the input comprises a character assigned to the character key in response to touch activation of the character key as magnified.

In an aspect, a grouping component groups the character key with the at least one neighboring character key determined to be adjacent to the character key to generate the character key group comprising the character key and the at least one neighboring character key. Without limitation, a character key can be any key on any keyboard, virtual or physical. For instance, a character key can reference a letter, numeral, symbol, sign, function (e.g. F1, F2, Delete, Shift, Enter, Caps Lock, Control, Backspace, Arrows, etc.), or any key found on a standard keyboard (e.g. desktop computer keyboard, laptop computer, tablet, mobile phone, personal digital assistant, etc.). In an aspect, character keys comprising a virtual keyboard can be configured to display character keys representing various languages. For instance, a virtual keyboard presenting Chinese character keys can reference a Chinese radical or other Chinese character elements. In another aspect, a zooming component enlarges the character key group as magnified and discontinues displaying at least one unmagnified character key associated with the virtual keyboard. In yet another aspect, a scrolling component that scrolls over a character key group to magnify the respective character key group via touch activation of the character key group via virtual directional touch arrows.

In another non-limiting embodiment, a method is provided, comprising facilitating, by a system comprising a processing device, presentation of a virtual keyboard by a user interface of the system, wherein the virtual keyboard comprises an integer number of character keys, associating at least one touch point of the user interface to a character key group comprising a character key and at least one neighboring character key that is adjacent to the character key, magnifying the character key group associated with the at least one touch point in response to touch activation of the at least one touch point, corresponding at least one magnified touch point of the user interface to a magnified character key, wherein the at least one magnified touch point is a magnified version of the at least one touch point and the magnified character key is a magnified version of the character key, via a text box of the user interface, receiving input, comprising a character assigned to the character key in response to touch activation of the magnified character key.

Other embodiments and various non-limiting examples, scenarios and implementations are described in more detail below. The following description and the drawings set forth certain illustrative aspects of the specification. These aspects are indicative, however, have but a few of the various ways in which the principles of the specification may be employed. Other advantage(s) and novel feature(s) or element(s) of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1A illustrates a block diagram of an example system that can facilitate generating a virtual keyboard capable of regional zooming to enable users to perform accurate typing on small device displays.

FIG. 1B is a diagram of a non-limiting normal virtual keyboard, whereby for simplicity, only uppercase alphabet character keys are shown.

FIG. 2 illustrates a block diagram of an example system that can facilitate generating a virtual keyboard capable of regional zooming and grouping character keys.

FIG. 3A illustrates a block diagram of an example system that can facilitate generating a virtual keyboard capable of regional zooming.

FIG. 3B is a diagram of a non-limiting virtual keyboard whereby the character key sizes are enlarged in the vertical direction.

FIG. 4 illustrates a block diagram of an example system that can facilitate generating a virtual keyboard capable of regional zooming and scrolling over a character key group.

FIG. 5 illustrates a block diagram of an example system that can facilitate generating a virtual keyboard capable of regional zooming and scrolling over a character key group via user operated swiping.

FIG. 6A illustrates a block diagram of an example system that can facilitate generating a virtual keyboard capable of regional zooming and reverting to a virtual keyboard display.

FIG. 6B is a diagram of enlarged character keys in a neighboring area of a touch point being displayed and including a reversion icon, directional scrolling arrows, and a labeled touch point.

FIG. 7A illustrates a block diagram of an example system that can facilitate generating a virtual keyboard capable of regional zooming and separating a region of the device user interface.

FIG. 7B is a diagram whereby neighboring keys are displayed in a separate area on a device display.

FIG. 8A illustrates a block diagram of an example system that can facilitate generating a virtual keyboard capable of regional zooming and labeling with a symbol at a touch point.

FIG. 8B is a diagram of a virtual keyboard and arrow keys used to correct a mistake.

FIG. 9 illustrates a block diagram of an example system that can facilitate generating a virtual keyboard capable of regional zooming and contrasting one or more character key.

FIG. 10 illustrates a block diagram of an example system that can facilitate generating a virtual keyboard capable of regional zooming and determining the number of character keys based at least on historical data.

FIG. 11A illustrates a block diagram of an example system that can facilitate generating a virtual keyboard capable of regional zooming and displaying one or more character key or character key as magnified.

FIG. 11B is a diagram of a virtual keyboard whereby a group of character keys in the same row are zoomed horizontally and highlighted after the virtual keyboard is zoomed in the vertical direction.

FIG. 11C is a diagram of a virtual keyboard whereby a group of character keys in three neighboring rows are zoomed horizontally and highlighted and the overall keyboard size remains the same.

FIGS. 12-14 illustrate a flow diagram of an example method that can facilitate generating a virtual keyboard capable of regional zooming.

FIG. 15 illustrates a flow diagram of an example method for generating a list of empty removable storage devices connected to a host device in accordance with an embodiment of the disclosed subject matter.

FIG. 16 illustrates a flow diagram of an example method for creating a secure volume file for an empty removable storage device in accordance with another embodiment of the disclosed subject matter.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer or an electronic device related entity, hardware, software (e.g., in execution), and/or firmware. For example, a component can be a processor, a process running on a processor, an object, an executable, a program, a storage device, and/or a computer, a mobile phone or other electronic device. By way of illustration, an application running on a server and the server can be a component. One or more components can reside within a process, and a component can be localized on one computer or an electronic device and/or distributed between two or more computers or devices.

Further, these components can execute from various computer or electronic device readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry. The electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts. The electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer or a device to implement the disclosed subject matter. The term “article of manufacture” as used herein is intended to encompass a computer program or instructions to a processor accessible from any electronically readable device, carrier, or media. For example, electronically readable media can include, but are not limited to, a magnetic storage device, e.g., hard disk, floppy disk, magnetic strip(s), an optical disk (e.g., compact disk (CD), a digital video disc (DVD), a Blu-ray Disc™ (BD)), a solid state drive (SSD), a smart card, a flash memory device (e.g., card, stick, key drive), and/or a virtual device that emulates a storage device and/or any of the above computer-readable media.

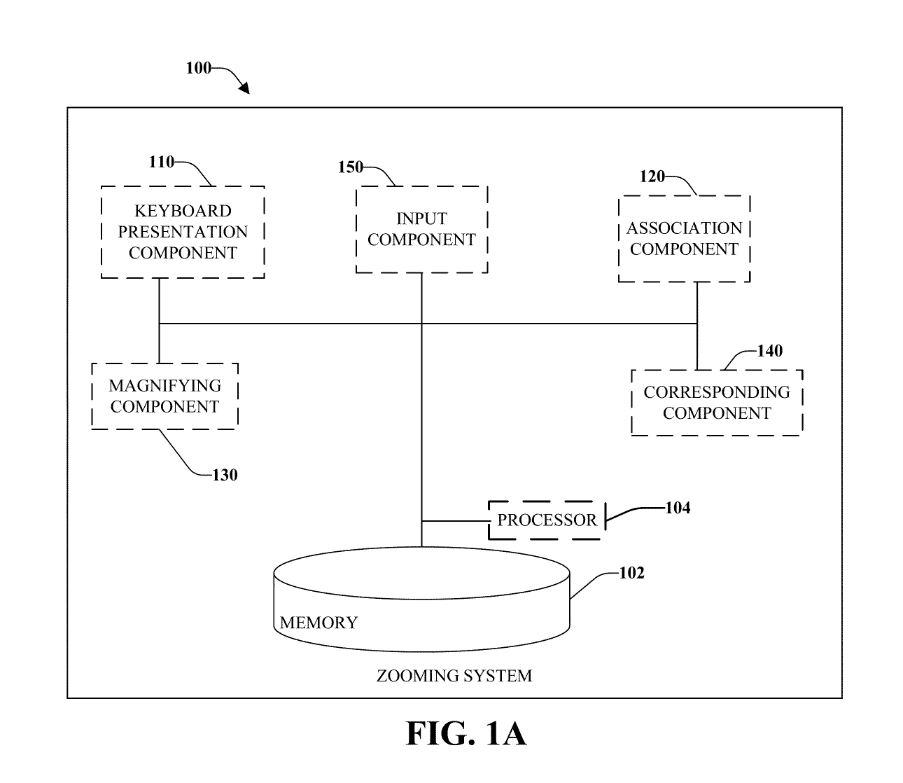

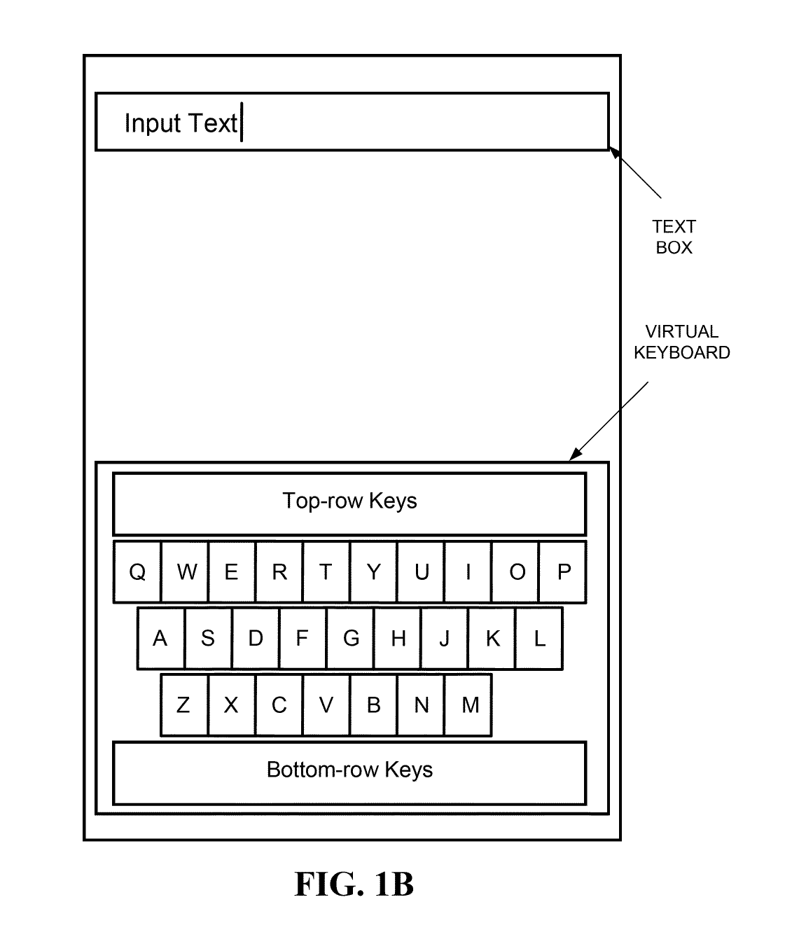

Referring now to the drawings, with reference initially to FIG. 1A, presented is a block diagram of an example system 100 than can facilitate generating a virtual keyboard capable of regional zooming to enable users to perform accurate typing on small device displays. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), mobile phone(s), virtual machine(s), etc. can cause the machine(s) to perform the operations described. System 100 can include memory 102 for storing device-executable components and instructions. A processor 104 can facilitate operation of the computer executable components and instructions by the system 100.

In an embodiment, the system 100 can include a keyboard presentation component 110, association component 120, magnifying component 130, corresponding component 140, and input component 150. In an aspect, keyboard presentation component 110 generates a virtual keyboard for presentation by a user interface, wherein the virtual keyboard comprises an integer number of character keys. Association component 120 associates at least one touch point of the user interface to a character key group comprising a character key and at least one neighboring character key that is adjacent to the character key. Magnifying component 130 magnifies the character key group associated with the at least one touch point in response to touch activation of the at least one touch point. Corresponding component 140 corresponds the at least one touch point as magnified to the character key as magnified. Input component 150 receives input, via a text box of the user interface, wherein the input comprises a character assigned to the character key in response to touch activation of the character key as magnified.

A virtual keyboard (a non-limiting embodiment of a virtual keyboard is illustrated in FIG. 1B) is a tool comprised of character keys that enable a user to enter one or more characters via a text box. Many devices, such as a mobile phone, personal digital assistant, tablet, handheld computer and other such devices are capable of presenting a virtual keyboard at a device display. A user can interact with the virtual keyboard via a user interface whereby the user can touch, tap, click, drag, or point at displayed character keys at a device display (e.g., touchscreen). In an aspect, system 100 employs keyboard presentation component 110 that generates a virtual keyboard for presentation by a user interface, wherein the virtual keyboard comprises an integer number of character keys. For instance, presentation component 110 can generate a virtual keyboard comprising thirty-six character keys, each key representing a unique alphanumeric character. Furthermore, the virtual keyboard can be comprised of one or more rows of character keys, each row comprising the same number or a different number of character keys.

In an aspect, a user can interact with the virtual keyboard via touch or tapping whereby the user touches a touch point associated with a character key to interact with the virtual keyboard. A touch point is a touch activation sensor affiliated with one or more respective character keys. Often, the touch point is not visible to the user; however, as the user touches a desired character key, the touch point associated with the character key is activated. In an aspect, a touch point can be associated to one or more character keys referred to as a character key group. The system 100 employs association component 120 to associate at least one touch point of the user interface to a character key group comprising a character key and at least one neighboring character key that is adjacent to the character key. Thus, for instance, association component 120 can associate a touch point on character key G to a character key group comprising T, Y, F, G, H, V, and B character keys respectively, each character key displayed adjacent to one another. In another aspect, association component 120 can associate a touch point to only one character key such as T character key respectively. Furthermore, association component 120 can associate a touch point to many character keys in a character key group displayed adjacent to one another in a diagonal line, column or row such as E, R, T, Y, U, I, and O character keys respectively.

A virtual keyboard can be presented at a device comprising a small display, which can cause a user to inaccurately touch desired character keys, due to the tight confinement of such character keys in the absence of more display area. System 100, overcomes this problem by employing magnifying component 130 that magnifies the character key group associated with the at least one touch point in response to touch activation of the at least one touch point. Thus, a user can touch a touch point correlated to a character key group thereby enlarging the respective character keys comprising such character key group in order to accurately touch the intended character key. By magnifying a group of character keys, magnifying component 130 enables a user to touch a character key that spans a greater area of the device display, thereby providing a user more space to type in order to allow for greater typing accuracy.

Activation of a touch point occurs by a user touching the touch point or sensor on a device display. A user can touch a touch point as magnified associated with a character key as magnified to select a desired character key for input via a text box. System 100 employs a corresponding component 140 that corresponds the at least one touch point as magnified to the character key as magnified. In an aspect, corresponding component 140 corresponds touch points as magnified to a respective character key as magnified to facilitate user typing of intended characters presented on a virtual keyboard. By touching the touch point as magnified a user activates the magnified touch sensor for a respective character key as magnified and input component 150 inputs the character assigned to such magnified version of the character key via a text box.

Thus, input component 150 receives input, via a text box of the user interface, wherein the input comprises a character assigned to the character key in response to touch activation of the character key as magnified. A text box (a non-limiting embodiment is illustrated in FIG. 1B) is a display area dedicated for entering characters such as a single-line form text box or text search box. A text box allows a user to interact digitally with the device (e.g., surf the internet, word process, etc.) or other user devices (e.g., sending e-mail or text messages) by entering one or more characters to create meaning (e.g., enter words, e-mail addresses, etc.). The input component 150 receives character data related to a user activated touch point and inputs the character data via a text box. A user can repeat the activation of several touch points to effectively input letters, numbers, words and symbols via a text box with greater accuracy due to the enlarged nature of the magnified character keys. If a user magnifies the wrong character key group, the user can restore the virtual keyboard to its original display mode by touching a touch point not associated with a character key as magnified.

In an aspect, keyboard presentation component 110, association component 120, magnifying component 130, corresponding component 140, and input component 150 can interact with one another in a variety of non-limiting configurations. For instance, keyboard presentation component 110 can generate a virtual keyboard for presentation by a user interface. A user intending to enter character “G” can touch a particular touch point associated with a character key group; for example, the user can touch the touch point for the group of characters comprising F, G, H, T, Y, V, and B. Thus, if a user touches the character key representing the character G, the association component 120 can associate the touch point related to character “G” with a character key group comprising F, G, H, T, Y, V, and B. The magnifying component 130 can magnify the character keys representing F, G, H, T, Y, V, and B in response to touch activation of the touch point related to character “G”. The user can easily touch the touch point as magnified assigned to a desired character key as magnified.

Furthermore, the corresponding component 140 corresponds the touch point as magnified of the user interface to a character key as magnified in response to touch activation of the character key as magnified by the user. The character key data associated with the activated touch point as magnified is received by input component 150 at a text box of the user interface. Thus, whereby a user touches the character key as magnified assigned to the letter F, a text box of the user interface will display the letter F. The user can repeatedly touch activate enlarged character keys to input strings of letters, numbers, symbols or words into a text box. The user can experience a higher degree of accurate typing and an enhanced user experience by utilizing a virtual keyboard with the ability to present enlarged character keys on a device display. Additionally, as accurate typing on mobile phones and other devices with small display sizes become easier, more miniaturized devices can be developed accommodating multi-touch and virtual keyboard functions.

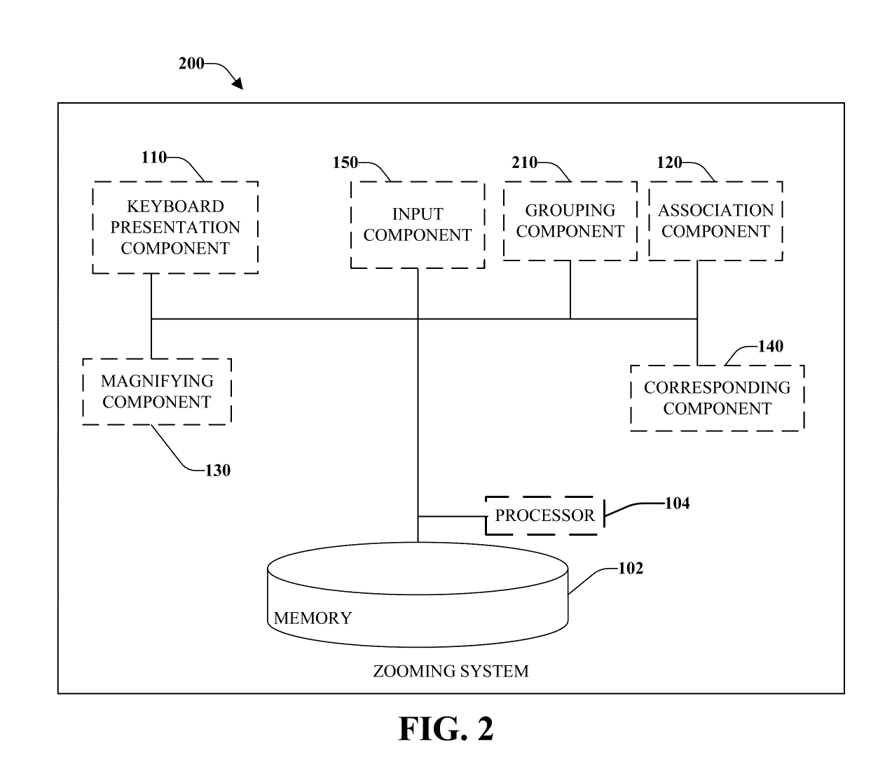

Turning now to FIG. 2, presented is another non-limiting embodiment of system 200 in accordance with the subject of the disclosure. In an aspect, grouping component 210 groups the character key with the at least one neighboring character key determined to be adjacent to the character key to generate the character key group comprising the character key and the at least one neighboring character key. A character key group is a collection of one or more character keys that can be magnified for easy user touching. In an aspect, a user can touch a touch point located at a region close to a desired character key and grouping component 210 can group a number of character keys associated with the desired character key or proximally located to the activated touch point region. For instance, a user can touch a touch point near character key S and grouping component 210 can generate a character key group comprising character keys A, W, E, S, D, X, and Z. The grouping component 210 can group a large number of character keys or a small number of character keys to comprise a character key group.

Furthermore, in an aspect, the grouping component 210 can group character keys based at least on user typing behavior. For example, if a user consistently touches the touch point near character key “F” and often types the magnified character key “T” then the grouping component 210 can group the character keys “F” and “T” in a character key group. By incorporating user history data and user behavior data to group character keys, the grouping component 210 provides the user highly meaningful feedback to allow the user to quickly find the correct intended character key for typing. Furthermore, grouping component 210 can operate in coordination with magnification component 130 to magnify the grouped character keys (e.g., by grouping component 210) for easy selection of desired character keys for typing. Also, this aspect of varying the constituency of character keys that comprise a magnified character key group can be based on historical user behavior data to predict the character key the user intended to touch and consequently group such character key for magnification (e.g., by using grouping component 210 in connection with learning component 1010, described further on in the description).

In an aspect, magnification component 130 in connection with grouping component 210 can magnify either an individual character key or the character key group at least one of diagonally, multi-dimensionally, horizontally, or vertically. For instance, character keys can be grouped (e.g., grouped by grouping component 210) in a diagonal line, thus a group of magnified characters keys can be the character keys associated with the character E, D, and C, which are adjacent to one another in a diagonal configuration (e.g., illustrated in FIG. 1B). Thus magnification component 130 in connection with grouping component 210 can group character keys as magnified in one or more configurations. Accordingly, grouping component 210 can increase or decrease the integer number of character key comprising a character key group. In an instance, a user can type the touch point associated with the character key H and the magnified character key group can comprise H, G, Y, U, J, B, and N. In another instance, the user can touch the touch point associated with the character key L and the character key group as magnified can comprise K, O, P, L, plus possible neighboring punctuation keys omitted in FIG. 1B, which differs from the previous group in number of characters magnified.

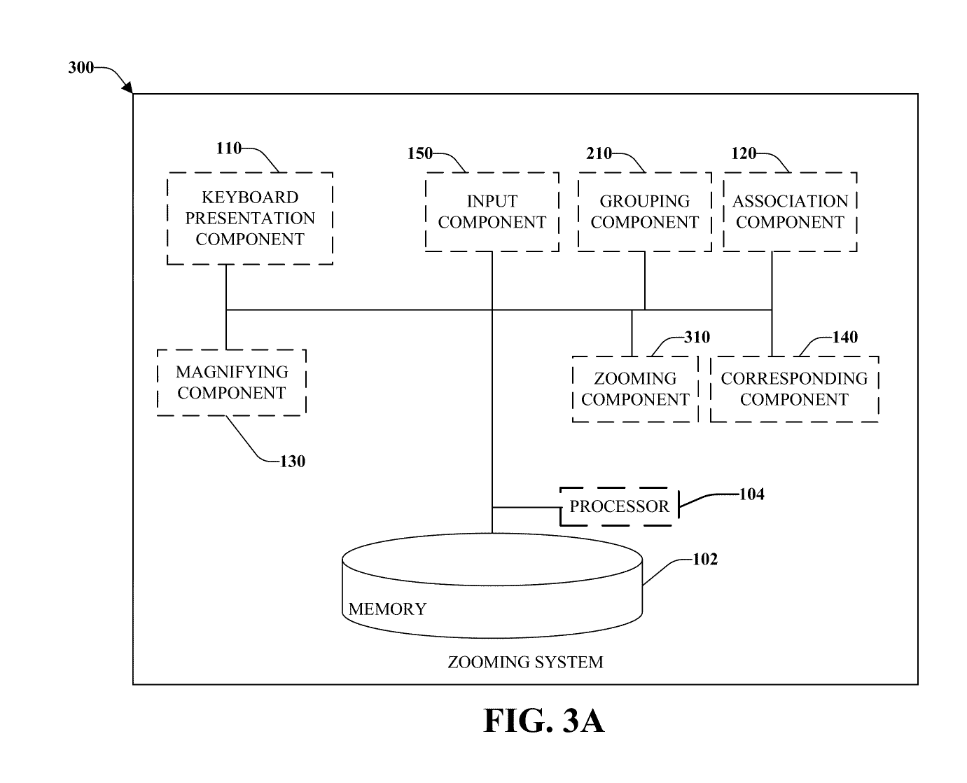

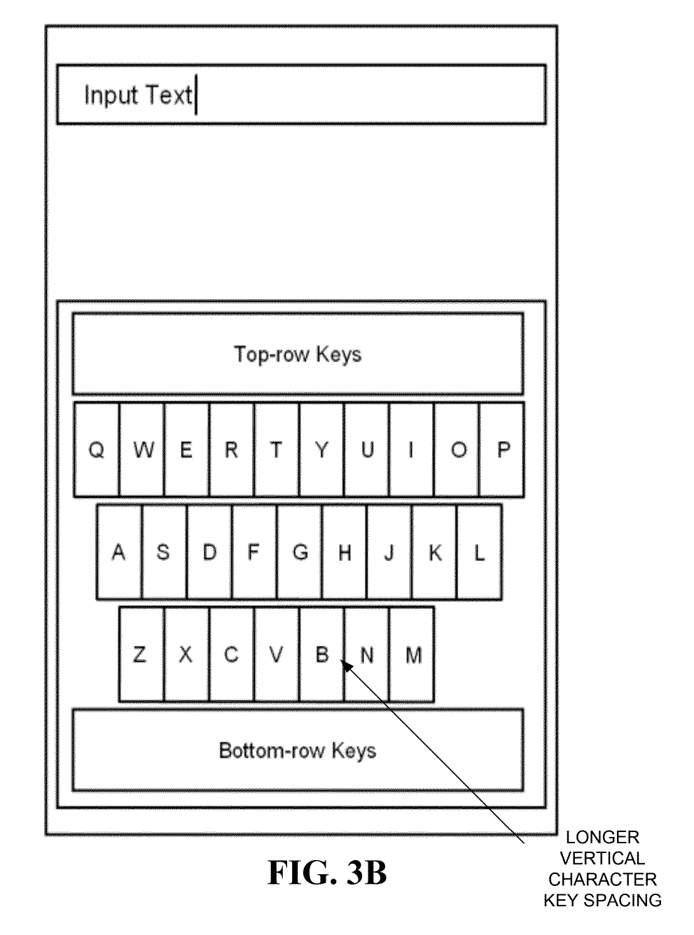

Turning now to FIG. 3A, presented is another non-limiting embodiment of system 300 in accordance with the subject of the disclosure. In an aspect, zooming component 310 enlarges the character key group as magnified and discontinues displaying at least one unmagnified character key associated with the virtual keyboard. In an instance, the user may wish to utilize a significant area of the device display to present a character key group as magnified. Thus, zooming component 310 can zoom the character key group as magnified to a size wherein the original virtual keyboard is no longer visible due to a lack of display area. For instance, zooming component 310 can enlarge a character key group as magnified comprising “F, G, H, R, T, Y, V, B, and N” to occupy the entire display area previously occupied by the virtual keyboard and simultaneously cease to display the original virtual keyboard.

A user's ability to enlarge character key groups as magnified and discontinue displaying unmagnified character key groups can further facilitate accurate typing particularly for any user suffering from inaccurate typing due to poor eyesight or large fingers. In another aspect, zooming component 310 can enlarge character key groups as magnified and simultaneously display only a few unmagnified character keys. For instance, zooming component 310 can magnify “F, G, H, R, T, Y, V, B, and N” while displaying unmagnified keys C, D, R, U, J, and M, at the same time ceasing to display the character keys located at the periphery of the unmagnified virtual keyboard such as L, P, Q, W, E, A, S, Z, and X. Zooming component 310 can enlarge any combination of character key groups as magnified while either continuing or ceasing to display any combination of unmagnified character keys. Additionally, zooming component 310 can vertically (e.g., illustrated in FIG. 3B) or horizontally enlarge the size of the keys that comprise the virtual keyboard character keys. Users can utilize this feature to custom fit a virtual keyboard on device displays of varying screen size or regional area.

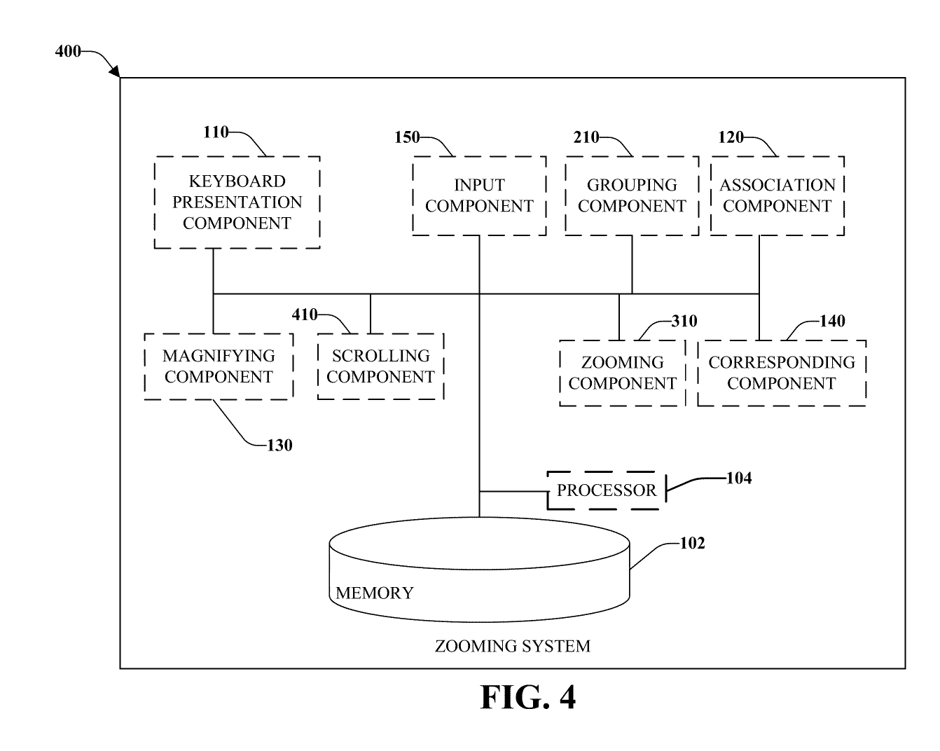

Turning now to FIGS. 4, 5, and 6 presented is another non-limiting embodiment of system 400 in accordance with the subject of the disclosure. In an aspect, scrolling component 410 scrolls over a character key group to magnify the respective character key group via touch activation of the character key group via virtual directional touch arrows. In an aspect, a user can magnify individual keys or character key groups by using scroll arrows to direct the respective character key or character key group to magnify. For instance, a user can touch character key “G” to magnify that character key and associated character key group (e.g., by using magnification component 130). Magnification component 130 in connection with scrolling component 410 can magnify the character key “H” and associated character key group by pressing a directional arrow pointing right. This would allow the user to find and type character “J, U, or N”. Scrolling component 410 can also allow a user to scroll left, up, down, and diagonally. The scrolling can occur by touch, activation of touch arrows, or use of a stylus or other such scrolling tools.

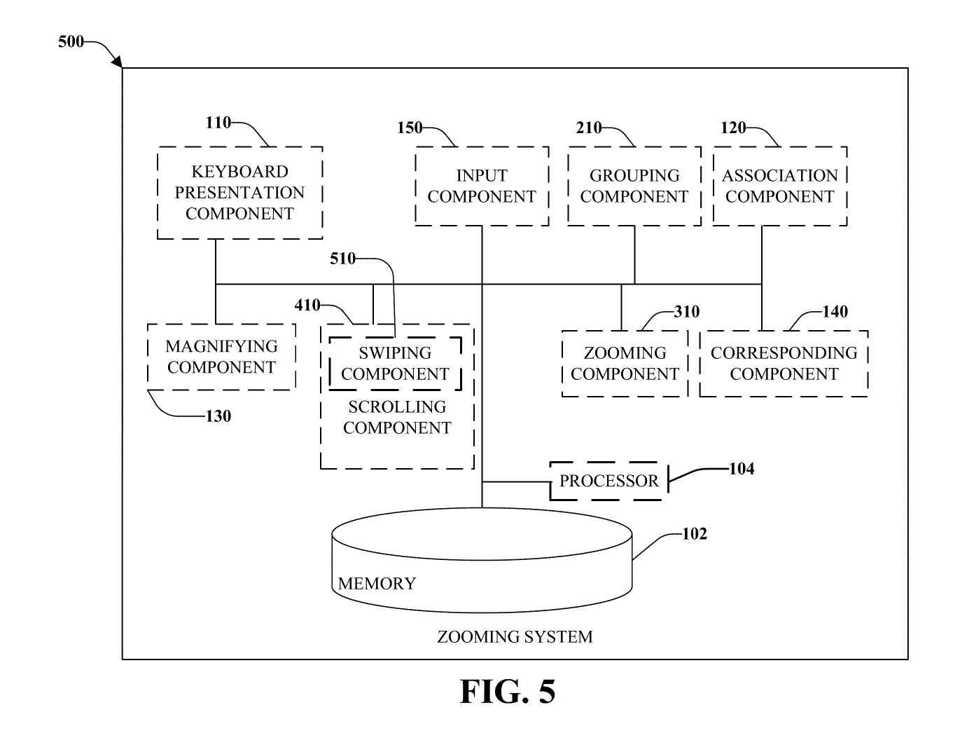

Additionally, a user can scroll over character key groups whereby many letters, numbers, and/or symbols are magnified when scrolled over by use of touch, activation of touch arrows, or use of a stylus. Further, scrolling component 410 in connection with magnification component 130 and grouping component 210 can allow a user to scroll across character key groups as magnified. For instance, a user can scroll across a character key group as magnified comprising F, T, and V and touch a directional arrow pointing left to scroll across and magnify a character key group of R, D, C whereby the character key group F, T, and V are unmagnified. Scrolling component 410 can provide a user with a more controlled mechanism of typing desired character keys with accuracy. In another aspect, scrolling component 410 can employ swiping component that scrolls over the character key group to magnify the respective character key group via user operated touch swiping input received by the virtual keyboard. Thus, scrolling component 410 in connection with swiping component 510 (illustrated in FIG. 5) can allow a user to use a swiping motion with a hand or fingers across the display to scroll from one character key to another character key or from one character key group to another character key group.

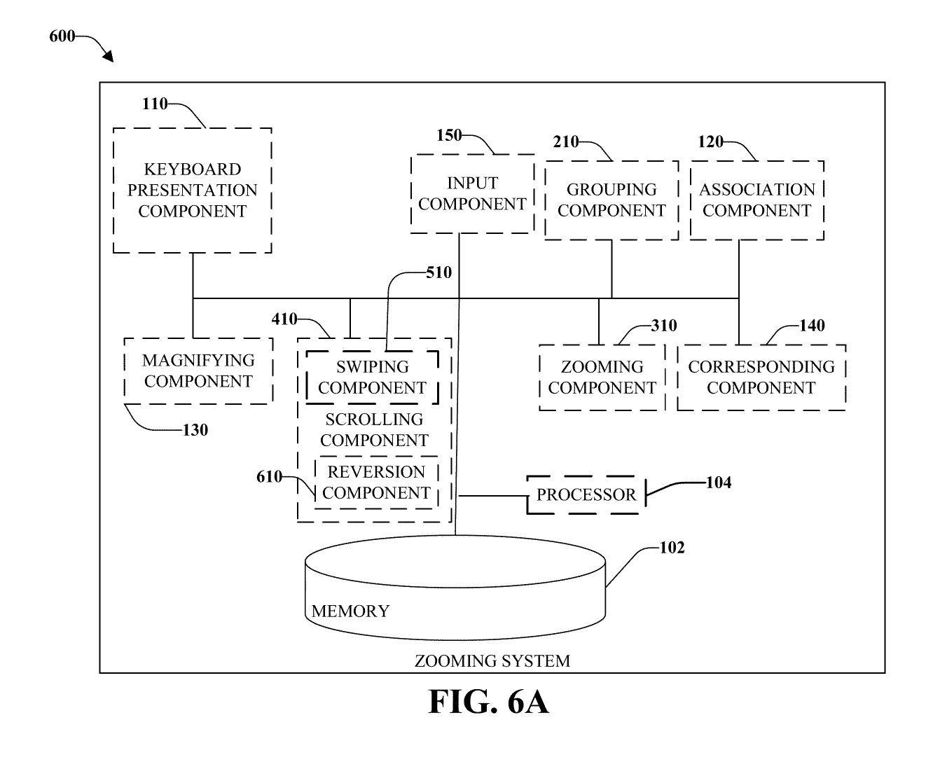

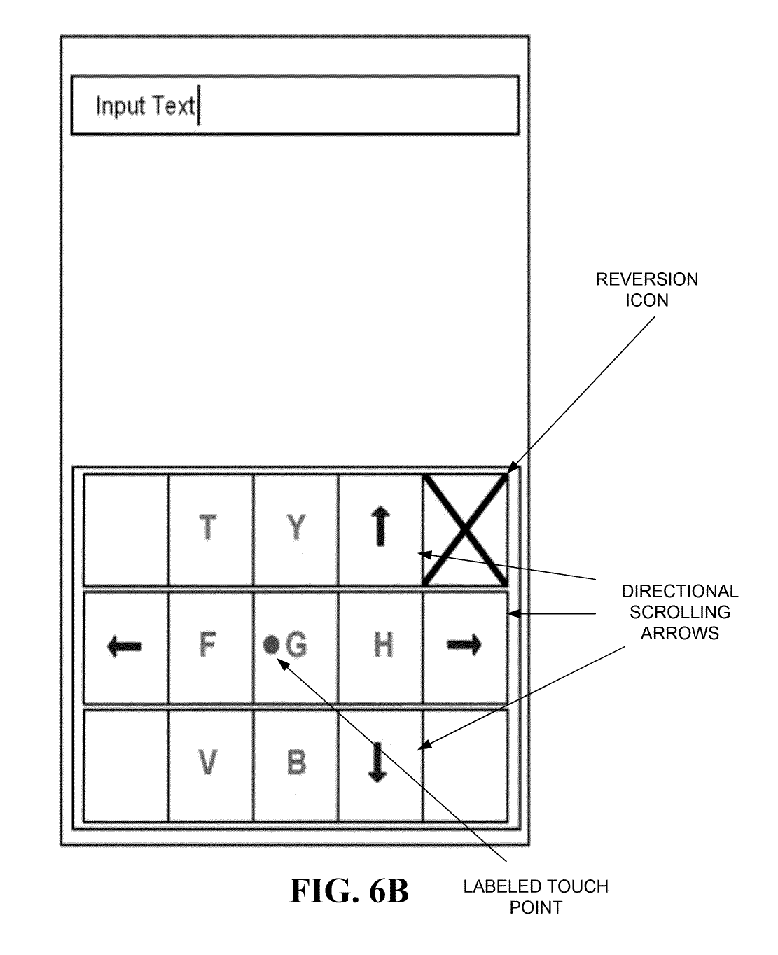

In another aspect, scrolling component 410 can employ reversion component 610 (illustrated in FIG. 6A) that reverts the character key group as magnified to a standard virtual keyboard display. In an aspect, reversion component can be a symbol or magnified character key icon such as a cross sign (illustrated in FIG. 6B) that can be used to revert the character key group as magnified to the original virtual keyboard display. Reversion component 610 in connection with swiping component 510 can allow a user to revert back to the original virtual keyboard display whereby a user applies a swiping motion or another gesture (e.g., display tapping, multiple finger motioning, etc.) to revert the character key group as magnified to the original virtual keyboard. In another aspect, for very small displays scrolling component 410 in connection with zooming component 310 can scroll over character keys as magnified (e.g., by using magnification component 130) that comprise a large area of the display whereby one or more of the character keys as magnified can comprise directional scrolling arrows (illustrated in FIG. 6B) to scroll across character keys as magnified (e.g., using scrolling component 410) or a character key as magnified can be a reversion icon (e.g., illustrated in FIG. 6B) to restore (e.g., using reversion component 610) the unmagnified original virtual keyboard display. Furthermore, in an aspect, swiping component 510 in connection with zooming component 310 can allow a user to utilize swiping gestures to scroll over character keys as magnified.

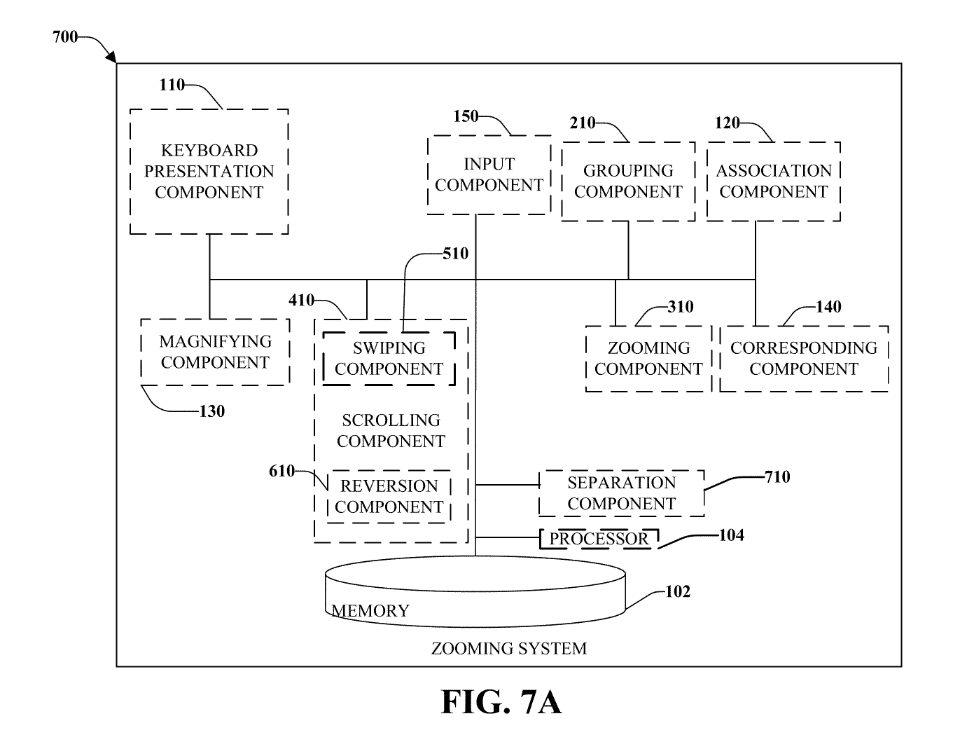

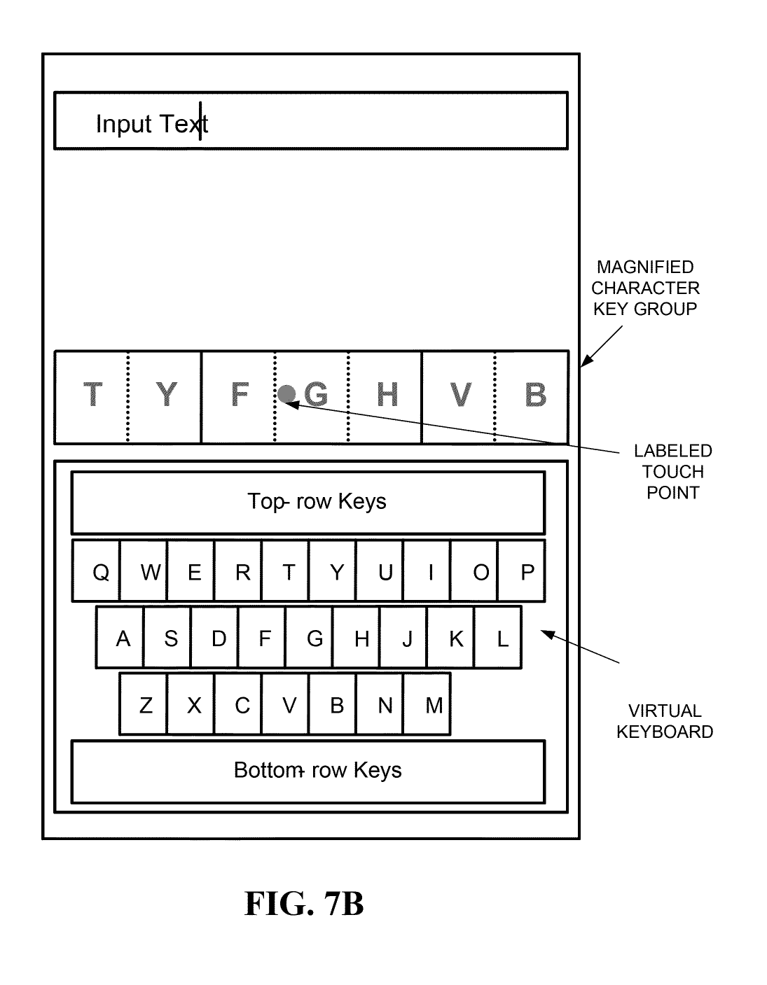

Turning now to FIG. 7A, presented is another non-limiting embodiment of system 700 in accordance with the subject of the disclosure. In an aspect, separation component 710 displays the character key group as magnified at a separate region of the device user interface without interfering with display of the virtual keyboard. In an aspect, a character key group as magnified does not have to be displayed in lieu of the unmagnified original keyboard, but rather, the character key group as magnified and the virtual keyboard can be displayed simultaneously at the same device display (illustrated in FIG. 7B). For instance, a user can touch a character key associated with a character key group (e.g., by using association component 120), whereby such character key group is displayed on a separate region (e.g., by using separation component 710) of the same device display (e.g., a row above the virtual keyboard) while the virtual keyboard is also displayed at a region of the device display.

As an example, a user can touch the unmagnified character key assigned to the character “G”. As a result, a character key group of character keys as magnified can be displayed in a row above the virtual keyboard (e.g., by using separation component 120), such as character keys as magnified comprising “T, Y, F, G, H, V, and B”. A user can easily touch the desired character key as magnified to input via a text box (e.g., by using input component 150). However, if the character key group as magnified does not comprise the desired character key, then the user can touch another point on the display (e.g., such as a point on the virtual keyboard, a point not located on the character key as magnified at the device display, etc.) to select a different character key group for display above the virtual keyboard (e.g., by using separation component 710). The separation component 710 allows for the virtual keyboard to remain intact while enabling the user to benefit from the use of character keys (e.g., increased typing accuracy) as magnified.

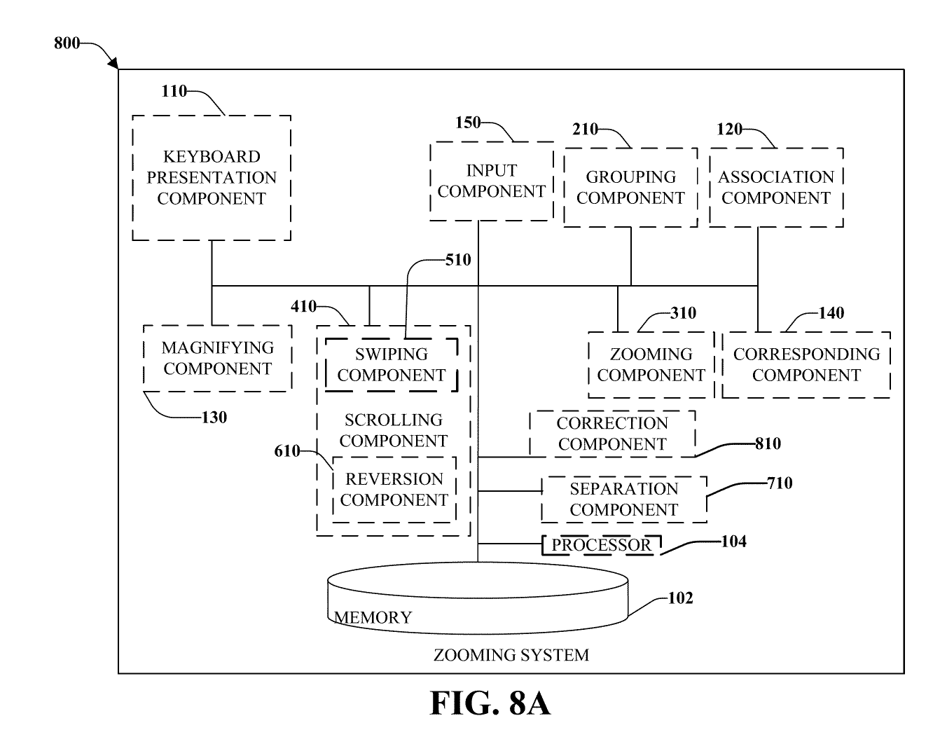

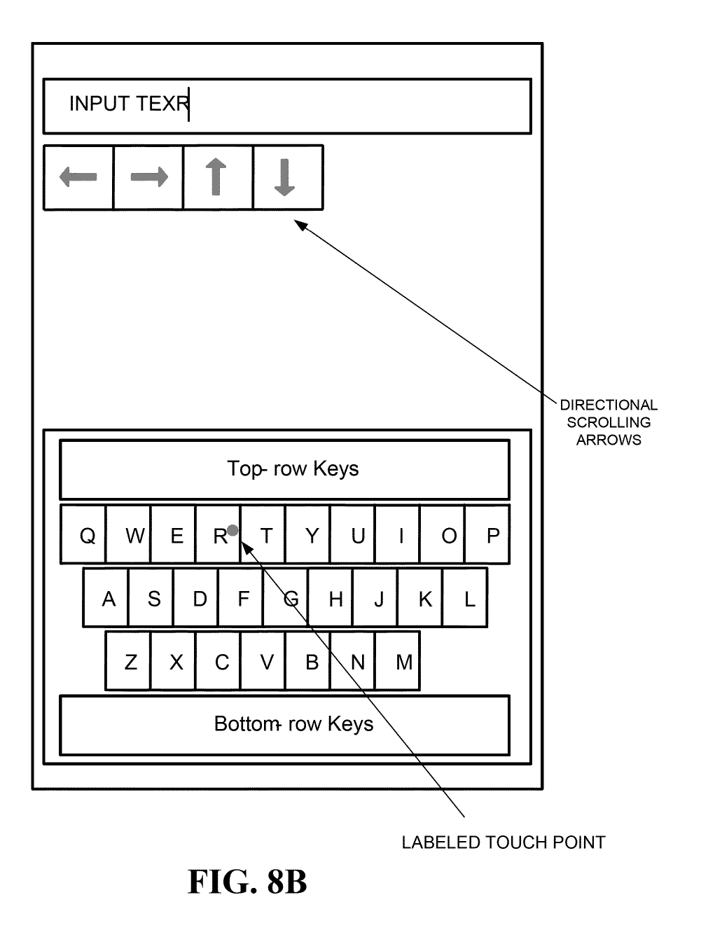

Turning now to FIG. 8A, presented is another non-limiting embodiment of system 800 in accordance with the subject of the disclosure. In an aspect, correction component 810 labels with a symbol a touch point corresponding to a most recent character input entered into the text box. In an instance, a user may discover a typing mistake whereby an incorrect character is input via a text box due to a mistype by the user. As such, the user may desire to forgo typing the correct desired character key and rather touch, or activate in some other manner, scrolling directional arrows to (e.g., by using scrolling component 410) navigate to the correct character key of choice. In such an instance, correction component 810 can label with a symbol (e.g., such as the red dot illustrated in FIGS. 8B, 7B, 6B), on the virtual keyboard, the character key of the most recent character input via the text box.

For example, if a user mistakenly typed the character “R” which was input via the text box (e.g., using input component 150), then correction component 810 can label with a symbol (e.g., the red dot illustrated in FIG. 8B) the character key associated with the character “R” on the virtual keyboard. Accordingly, the user can touch a directional scrolling arrow to scroll (e.g., by using scrolling component 410) to the correct desired character key. Thus, if the user intends to type the character key “U” as a correction to the mistyped character key “R”, then the user can touch the right directional scroll arrow three times and correction component 810 accordingly labels the character key associated with the character “U” with a symbol (e.g., red dot). Each touch of a directional scroll arrow will move the symbol in a direction in accordance with the directional scroll arrow touched. In an aspect, the correction is treated as final if the user touches any area of the display other than the presented directional scroll arrows. In the above example, if the user entered “INPUT TEXR”, via a text box (as illustrated in FIG. 8B), subsequently touches the right directional scroll arrow three times and subsequently touches the character key A, then the text box will display “INPUT TEXUA”.

In another aspect, the user can tap on the keyboard, touch an enter or return key, gesture across the keyboard, or perform a variety of other actions to finalize the correction. Additionally, correction component 810 can be used in connection with the swipe component 510 to label the character key input via a text box and scroll (e.g., by using swipe component 510) across other character keys using a swipe gesture. In an aspect, the correction component 810 labels the touch point or the touch point as magnified by at least one of a differentiated color, character key background, character key shape, character key shading, or character key font. Thus, correction component 810 can use a different symbol, a symbol other than a red circle, to label a character key or touch point, such as a star, asterisk, unique shape, smiley face, and so on. In another aspect, correction component 810 can label a character key or touch point by varying the color of the character key or touch point in a variety of ways (e.g., using a different color for the background of the key, the alphanumeric character on the key, etc.) or highlighting the character key or touch point in bold or a unique color.

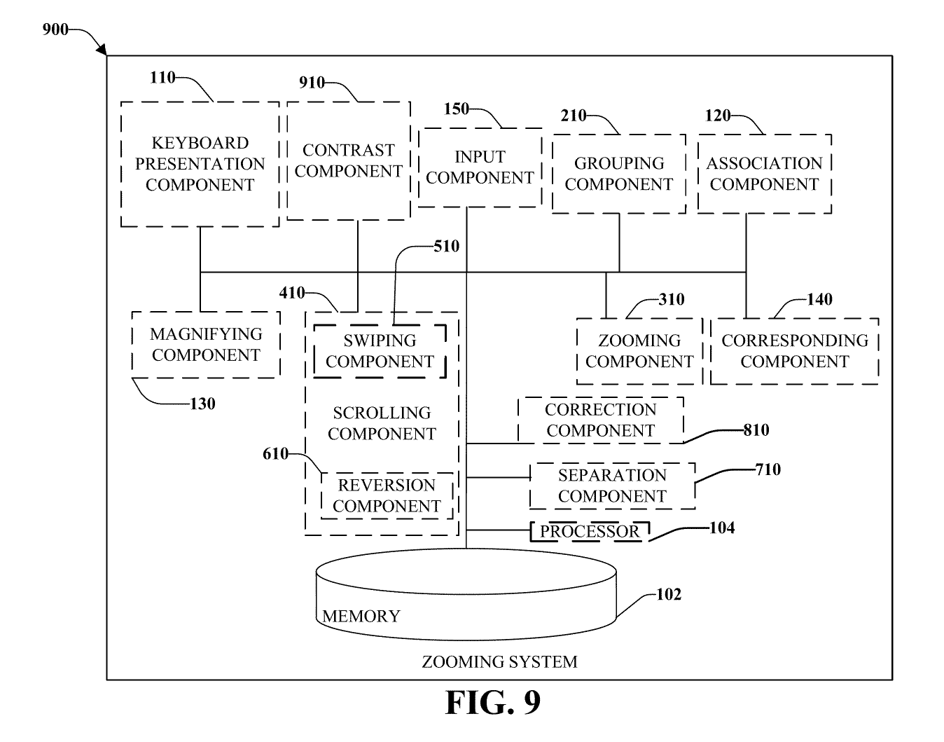

Turning now to FIG. 9, presented is another non-limiting embodiment of system 900 in accordance with the subject of the disclosure. In an aspect, a contrasting component 910 contrasts one or more character keys as magnified belonging to the character key group as magnified with one or more unmagnified character keys by at least one analysis of differentiation of font, character key background variation, character key color, or character key shape of the one or more magnified characters relative to the one or more unmagnified character keys. In an aspect, a magnified character key can be contrasted (by using contrasting component 910) by differentiating a magnified character key from another character key, in addition to enlarging the area, by changing respective features of a respective character key group. For instance, a magnified character key can be highlighted, colored, shaded, bolded, italicized, shaped, augmented or distinguished from unmagnified or other magnified character keys. Contrasting component 910 can facilitate user identification of an intended character key by providing visual attention (in addition to magnification) to respective character keys to promote greater user accuracy to particular character keys.

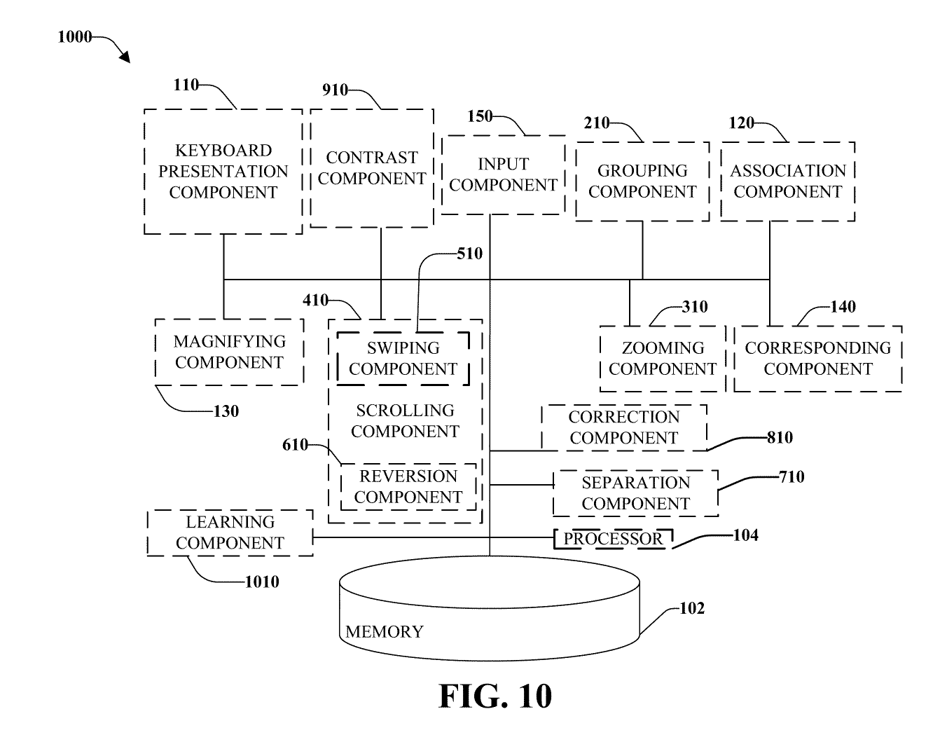

Turning now to FIG. 10, presented is another non-limiting embodiment of system 1000 in accordance with the subject of the disclosure. In an aspect, learning component 1010 determines the integer number of character keys or constituency of individual character keys that comprise the character key group based at least on historical data. In an aspect, learning component 1100 can utilize information related to user virtual keyboard usage, performance, and configuration to develop analytics that better predict users intended typing habits. These analytics can enhance the user experience and contribute to the accuracy of the character key groups to magnify for display to the user.

In an instance, learning component 1010 can receive feedback from label component 810 to determine the particular character keys to magnify. This type of real time up-to-date dynamism facilitates increased user typing accuracy and provides meaningful feedback to the user about where they can touch in order to enter an intended character. For instance, learning component 1010 can employ a probability distribution, or decision process to determine the intended character key to magnify for a particular user. For instance, if a user frequently touches to the left of a desired character key, then learning component 1010 in connection with magnification component 130 can magnify more character keys to the right of the touched character key. Furthermore, information related to a user's frequent behavior can be extrapolated from correction component 810, whereby if a user is frequently hitting a particular directional scroll arrow in connection with a respective character key, then learning component 1010 can consider such historical data in determining a constituency of character keys to comprise a character key group.

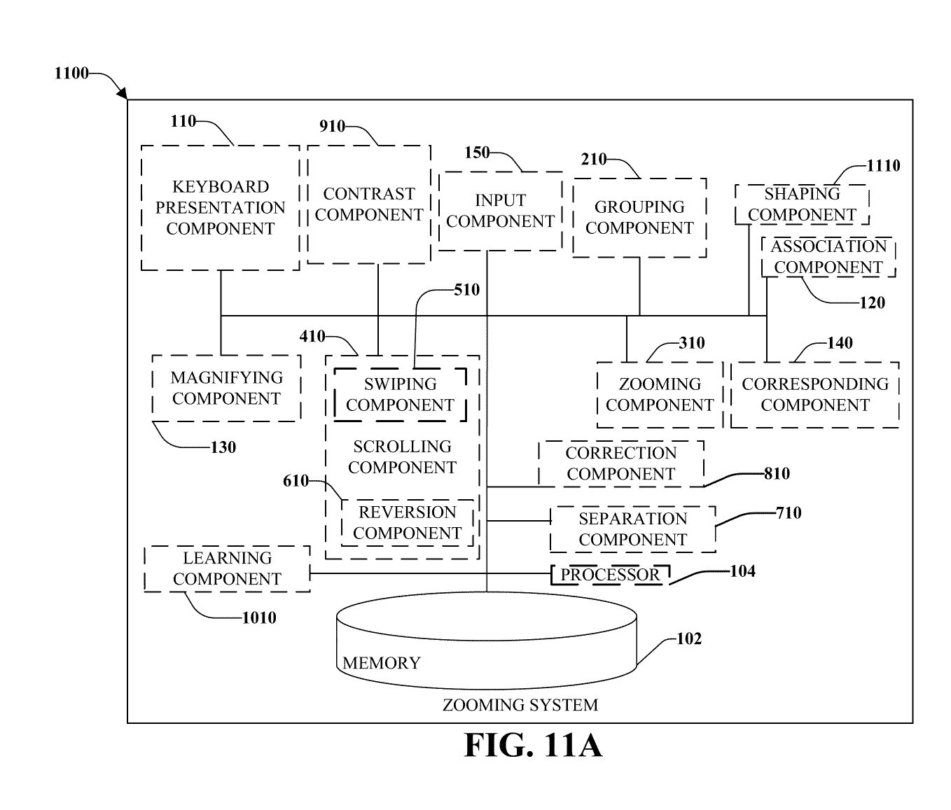

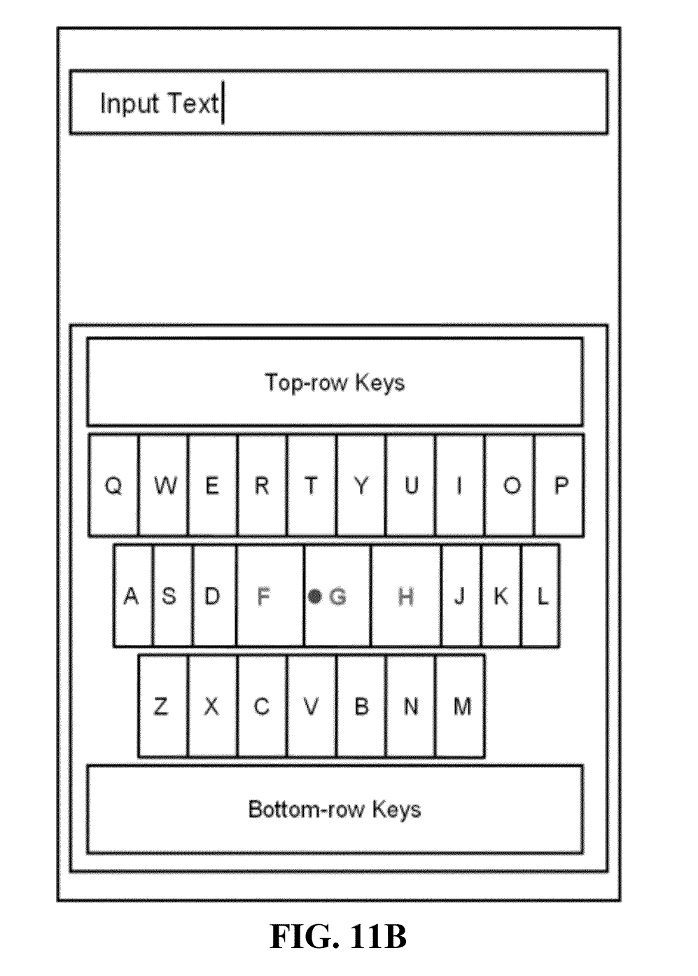

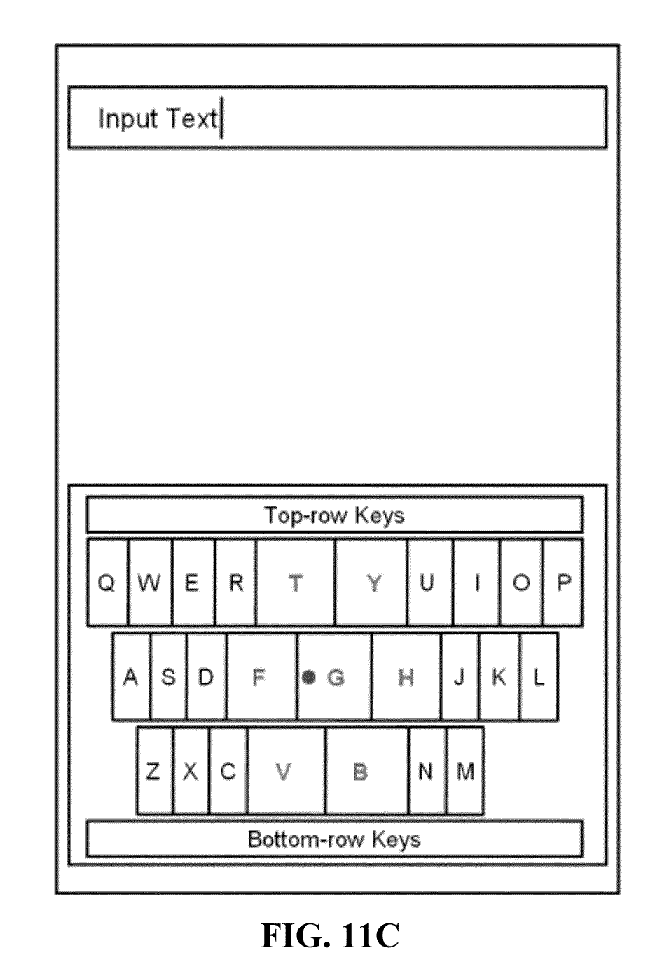

Turning now to FIG. 11A, presented is another non-limiting embodiment of system 1100 in accordance with the subject of the disclosure. In an aspect, a shaping component 1110 displays one or more character key or character keys as magnified according to at least one of a different size, or shape. In an aspect, shaping component 1110 can display each character key as magnified in a variety of shape or size configurations. For instance, character keys as magnified can be circle shaped keys, or horizontally wider sized character keys rather than vertically enlarged character keys. Shaping component 1110 allows the character key groups as magnified to adapt and custom fit various device displays.

For instance, if the virtual keyboard presentation component 110 presents a virtual keyboard whereby the vertical height of the unmagnified character keys are spaced with a sufficient height then shaping component 1110 in connection with magnification component 130 can optionally only increase the horizontal width (illustrated in FIG. 11B) of a character key group of character keys to be magnified. Alternatively, if a virtual keyboard presentation component 110 presents a virtual keyboard whereby the horizontal width of the character keys as magnified are spaced with a sufficient width then shaping component 1110 in connection with magnification component 130 can optionally increase only the vertical height of a character key group of character keys to be magnified. In general, system 1100 can optimize various processes (e.g., magnifying or shaping only limited features of a virtual keyboard) associated with facilitating accurate typing to a user.

Turning now to FIG. 11C, illustrated is non-limiting embodiment of a virtual key keyboard. In an aspect, a user can touch a touch point at the virtual keyboard, which is illustrated by the red circle at character key G. Upon touch of a touch point, shaping component 1110 in connection with magnification component 130 can highlight (e.g., by contrasting component 910) and increase the size of a character key group and decrease the size of other character keys (e.g., decrease the width or height of character keys that are not constituents of the character key group in the same row as highlighted character keys). In an instance, the virtual keyboard in its entirety does not need to occupy a larger display area (as is illustrated in FIG. 11B), but rather the individual character keys are re-sized within the area occupied by the original virtual keyboard in its entirety. If the desired character is not within the highlighted and magnified character group, the user can touch another point on the virtual keyboard and highlight and magnify the touched character and associated character group to find the desired character. In another aspect, a user can revert to the original virtual keyboard by touching a touch point located outside the keyboard.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

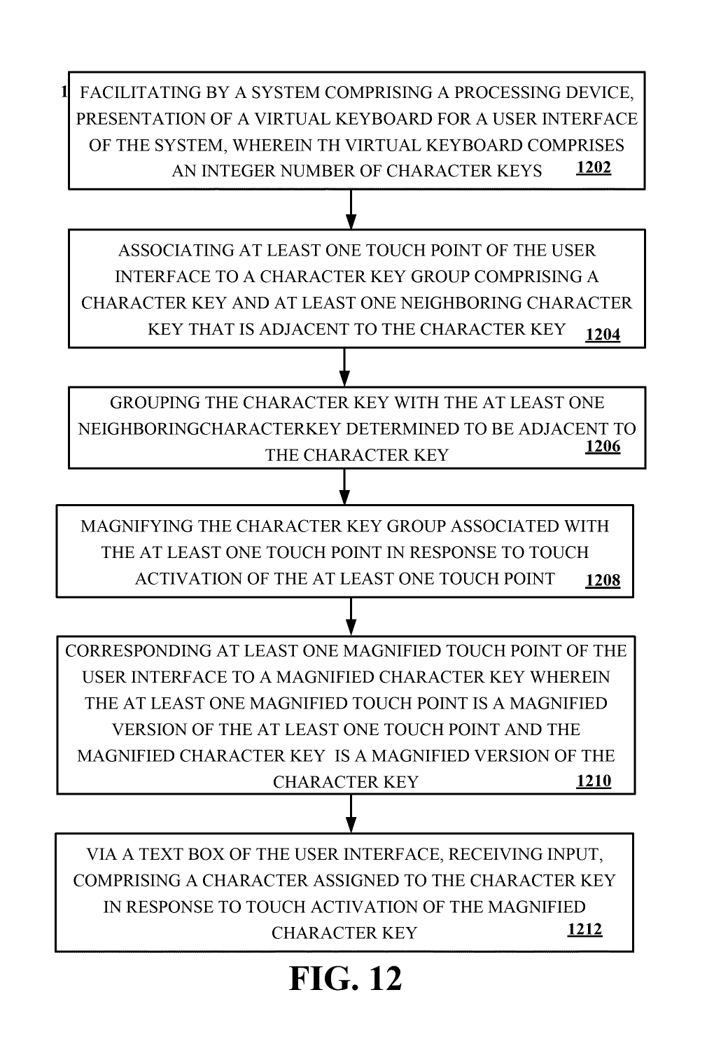

Turning now to FIGS. 12-14 illustrated are methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be further appreciated that the methods disclosed hereinafter and throughout this specification are capable of being stored on an article of manufacture to facilitate transporting and transferring such methods to computers and/or electronic devices. The term article of manufacture, as used herein, is intended to encompass a program or a set of instructions accessible from any electronically readable device, carrier, or media.

Referring to FIG. 12, an example method 1200 that can generate a virtual keyboard capable of regional zooming to facilitate accurate typing on small displays in accordance with various embodiments and aspects of the disclosed subject matter is illustrated. At 1202, a system can be configured to facilitate a processing device to present (e.g., by using keyboard presentation component 110) a virtual keyboard by a user interface of the system, wherein the virtual keyboard comprises an integer number of character keys. At 1204, at least one touch point of the user interface can be associated (e.g., by using association component 120) to a character key group comprising a character key and at least one neighboring character key that is adjacent to the character key. At 1206, the character key group associated with the at least one touch point can be magnified (e.g., by using magnification component 130) in response to touch activation of the at least one touch point. At 1208, at least one magnified touch point of the user interface can be corresponded (e.g., by corresponding component 140) to a magnified character key, wherein the at least one magnified touch point is a magnified version of the at least one touch point and the magnified character key is a magnified version of the character key. At 1210, input can be received (e.g., by using input component 150), via a text box of the user interface, comprising a character assigned to the character key in response to touch activation of the magnified character key.

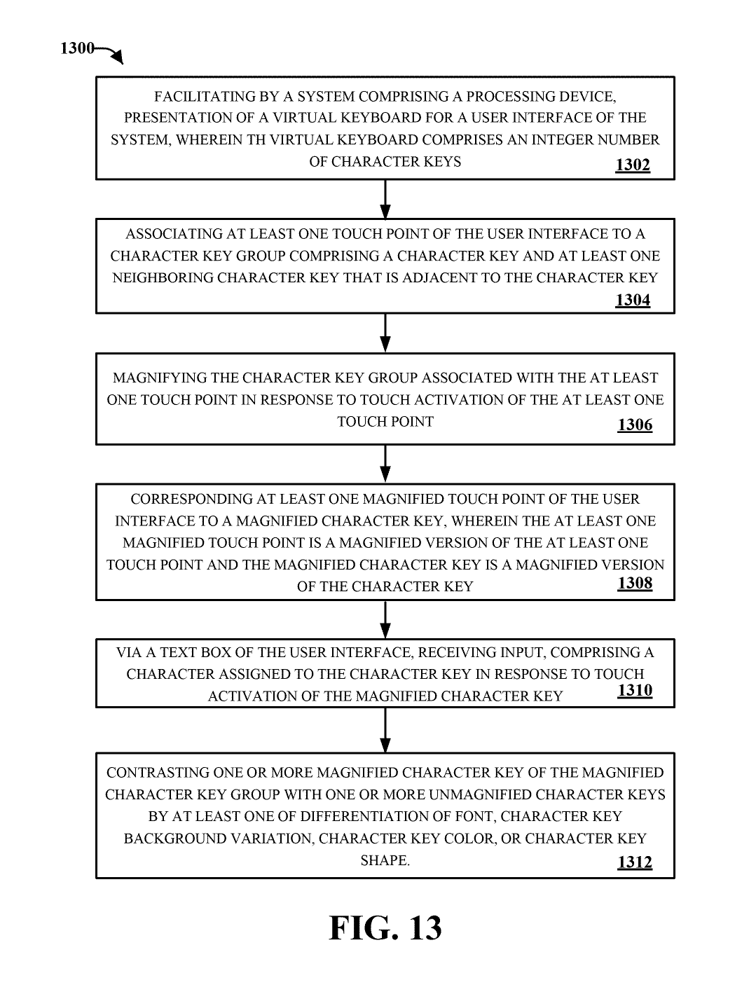

Referring to FIG. 13, an example method 1300 that can generate a virtual keyboard capable of regional zooming to facilitate accurate typing on small displays in accordance with various embodiments and aspects of the disclosed subject matter is illustrated. At 1302, a system can be configured to facilitate a processing device to present (e.g., by using keyboard presentation component 110) a virtual keyboard by a user interface of the system, wherein the virtual keyboard comprises an integer number of character keys. At 1304, at least one touch point of the user interface can be associated (e.g., by using association component 120) to a character key group comprising a character key and at least one neighboring character key that is adjacent to the character key.

At 1306, the character key group associated with the at least one touch point can be magnified (e.g., by using magnification component 130) in response to touch activation of the at least one touch point. At 1308, at least one magnified touch point of the user interface can be corresponded (e.g., by corresponding component 140) to a magnified character key, wherein the at least one magnified touch point is a magnified version of the at least one touch point and the magnified character key is a magnified version of the character key. At 1310, input can be received (e.g., by using input component 150), via a text box of the user interface, comprising a character assigned to the character key in response to touch activation of the magnified character key. At 1312, contrasting one or more magnified character keys of the magnified character key group with one or more unmagnified character keys by at least one of differentiation of font, character key background variation, character key color, or character key shape.

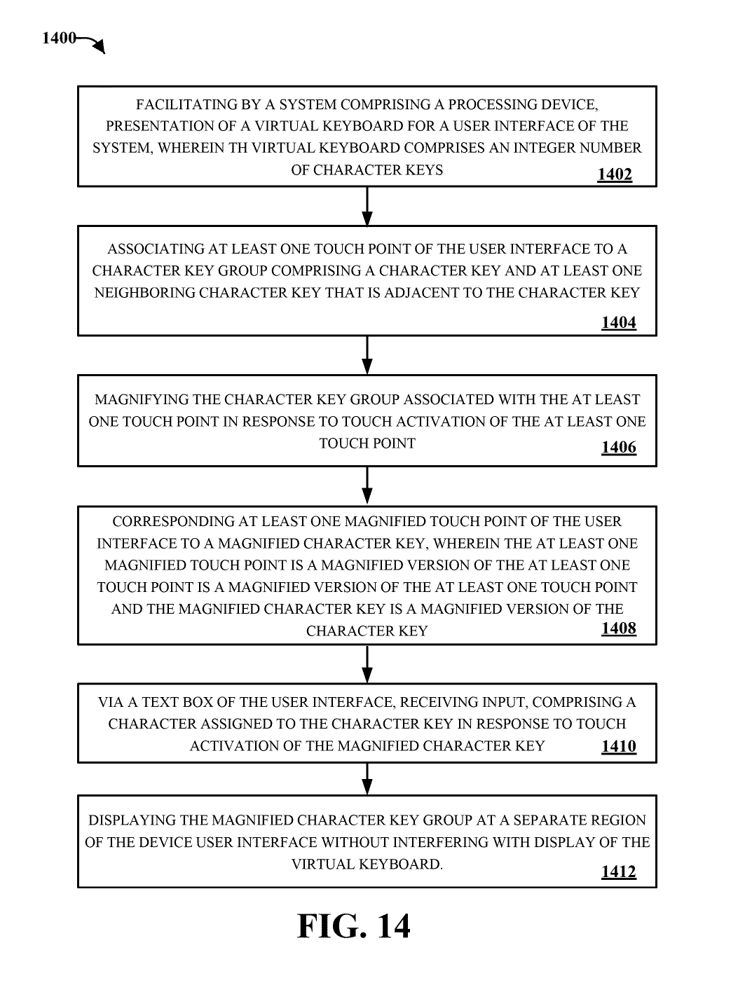

Referring to FIG. 14, an example method 1400 that can generate a virtual keyboard capable of regional zooming to facilitate accurate typing on small displays in accordance with various embodiments and aspects of the disclosed subject matter is illustrated. At 1402, a system can be configured to facilitate a processing device to present (e.g., by using keyboard presentation component 110) a virtual keyboard by a user interface of the system, wherein the virtual keyboard comprises an integer number of character keys. At 1404, at least one touch point of the user interface can be associated (e.g., by using association component 120) to a character key group comprising a character key and at least one neighboring character key that is adjacent to the character key.

At 1406, the character key group associated with the at least one touch point can be magnified (e.g., by using magnification component 130) in response to touch activation of the at least one touch point. At 1408, at least one magnified touch point of the user interface can be corresponded (e.g., by corresponding component 140) to a magnified character key, wherein the at least one magnified touch point is a magnified version of the at least one touch point and the magnified character key is a magnified version of the character key. At 1410, input can be received (e.g., by using input component 150), via a text box of the user interface, comprising a character assigned to the character key in response to touch activation of the magnified character key. At 1412, the magnified character key group is displayed at a separate region of the device user interface without interfering with display of the virtual keyboard.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

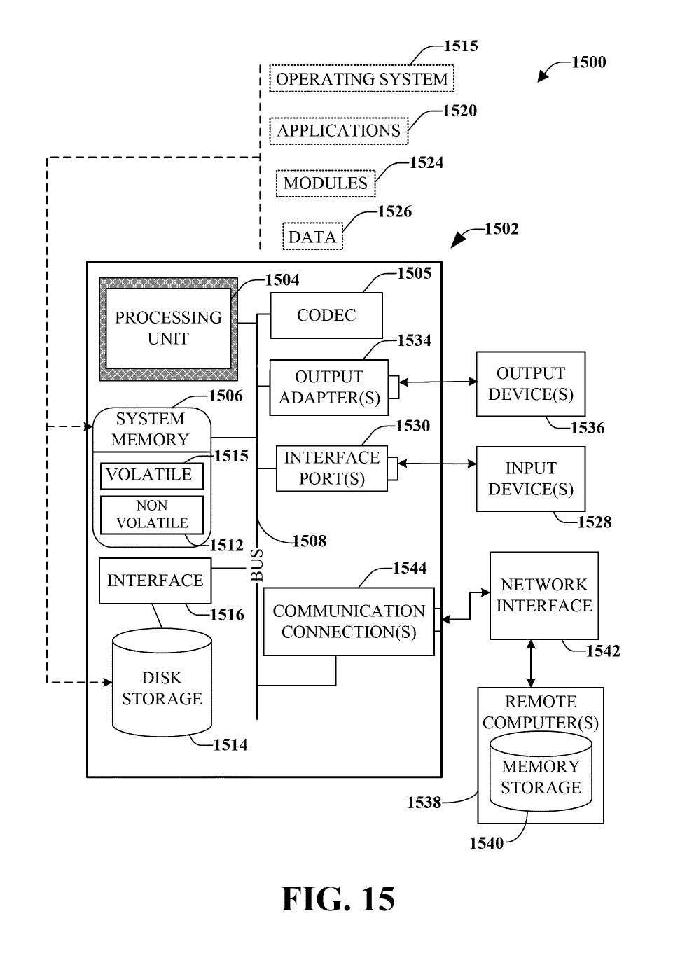

With reference to FIG. 15, a suitable environment 1500 for implementing various aspects of the claimed subject matter includes a computing device 1502, such as a computer, tablet, mobile phone or personal digital assistant. The computing device 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1506 includes volatile memory 1510 and non-volatile memory 1512. The basic input/output system (BIOS), containing the basic routines to transfer information between elements within the computing device 1502, such as during start-up, is stored in non-volatile memory 1512. In addition, according to present innovations, codec 1505 may include at least one of an encoder or decoder, wherein the at least one of an encoder or decoder may consist of hardware, a combination of hardware and software, or software. Although, codec 1505 is depicted as a separate component, codec 1505 may be contained within non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. According to present aspects, the volatile memory may store the write operation retry logic (not shown in FIG. 15) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computing device 1502 may also include removable/non-removable, volatile/non-volatile computer storage medium. FIG. 15 illustrates, for example, disk storage 1514. Disk storage 1514 includes, but is not limited to, devices like a magnetic disk drive, solid state disk (SSD), floppy disk drive, tape drive, external drives, LS-70 drive, flash memory card, or memory stick. In addition, disk storage 1514 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software that acts as an intermediary between users and the basic computer resources described in the suitable operating environment 1500. Such software includes an operating system 1518. Operating system 1518, which can be stored on disk storage 1514, acts to control and allocate resources of the computing device 1502. Applications 1520 take advantage of the management of resources by the operating system through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems.

A user enters commands or information into the computing device 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s) 1528. Thus, for example, a USB port may be used to provide input to computing device 1502, and to output information from computing device 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computing device 1502 can operate in a networked environment using logical connections to one or more remote computers or devices, such as remote computer(s) 1538. The remote computer(s) 1538 can be a personal computer, a server, a router, a network PC, a workstation, a microprocessor based appliance, a peer device, a smart phone, a tablet, or other network node, and typically includes many of the elements described relative to computing device 1502. For purposes of brevity, only a memory storage device 1540 is illustrated with remote computer(s) 1538. Remote computer(s) 1538 is logically connected to computing device 1502 through a network interface 1542 and then connected via communication connection(s) 1544. Network interface 1542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computing device 1502, it can also be external to computing device 1502. The hardware/software necessary for connection to the network interface 1542 includes, for exemplary purposes only, internal and external technologies such as, modems including regular telephone grade modems, cable modems and DSL modems, ISDN adapters, and wired and wireless Ethernet cards, hubs, and routers.

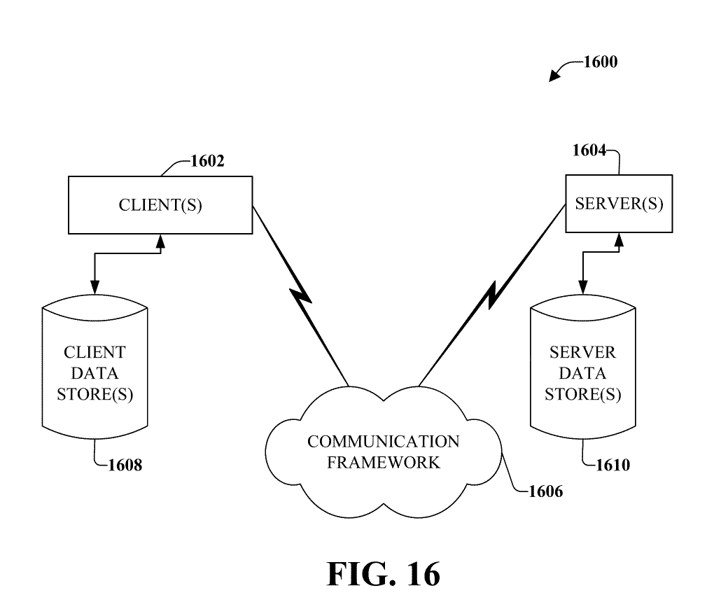

Referring now to FIG. 16, there is illustrated a schematic block diagram of a computing environment 1600 in accordance with this disclosure. The system 1600 includes one or more client(s) 1602 (e.g., laptops, smart phones, PDAs, media players, computers, portable electronic devices, tablets, and the like). The client(s) 1602 can be hardware and/or software (e.g., threads, processes, computing devices). The system 1600 also includes one or more server(s) 1604. The server(s) 1604 can also be hardware or hardware in combination with software (e.g., threads, processes, computing devices). The servers 1604 can house threads to perform transformations by employing aspects of this disclosure, for example. One possible communication between a client 1602 and a server 1604 can be in the form of a data packet transmitted between two or more computer processes wherein the data packet may include video data. The data packet can include a metadata, such as associated contextual information for example. The system 1600 includes a communication framework 1606 (e.g., a global communication network such as the Internet, or mobile network(s)) that can be employed to facilitate communications between the client(s) 1602 and the server(s) 1604.

Communications can be facilitated via a wired (including optical fiber) and/or wireless technology. The client(s) 1602 include or are operatively connected to one or more client data store(s) 1608 that can be employed to store information local to the client(s) 1602 (e.g., associated contextual information). Similarly, the server(s) 1604 are operatively include or are operatively connected to one or more server data store(s) 1610 that can be employed to store information local to the servers 1604.

In one embodiment, a client 1602 can transfer an encoded file, in accordance with the disclosed subject matter, to server 1604. Server 1604 can store the file, decode the file, or transmit the file to another client 1602. It is to be appreciated, that a client 1602 can also transfer uncompressed file to a server 1604 and server 1604 can compress the file in accordance with the disclosed subject matter. Likewise, server 1604 can encode video information and transmit the information via communication framework 1606 to one or more clients 1602.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as an electronically readable storage medium having machine or device-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to electronic device related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware, generalized hardware made specialized by the execution of software thereon that enables the hardware to perform specific function, software stored on an electronically readable storage medium, software transmitted on an electronically readable transmission medium, or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include electronically readable storage media and/or communications media, in which these two terms are used in this description differently from one another as follows. Electronically readable storage media can be any available storage media that can be accessed by an electronic device, is typically of a non-transitory nature, and can include both volatile and nonvolatile media, removable and non-removable media. By way of example, and not limitation, electronically readable storage media can be implemented in connection with any method or technology for storage of information such as electronically readable instructions, program modules, structured data, or unstructured data. Electronically readable storage media can include, but are not limited to, RAM, ROM, EEPROM, flash memory, solid state disk (SSD) or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Electronically readable storage media can be accessed by one or more local or remote computing devices, e.g., via access requests, queries or other data retrieval protocols, for a variety of operations with respect to the information stored by the medium.

On the other hand, communications media typically embody electronically readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optical, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to electronic devices. The term article of manufacture, as used in this disclosure, is intended to encompass software or a program accessible from any electronically readable device or storage media.

What is claimed is:

1. A system, comprising:
a memory to store device-executable components; and
a processor, communicatively coupled to the memory, that executes or facilitates execution of one or more device-executable components, the device-executable components, comprising:
a keyboard presentation component that generates a virtual keyboard for presentation by a user interface, wherein the virtual keyboard comprises an integer number of character keys;
an association component that associates at least one touch point of the user interface to a character key group comprising a character key and at least one neighboring character key that is adjacent to the character key;
a magnifying component that magnifies the character key group associated with the at least one touch point in response to touch activation of the at least one touch point;
a corresponding component that corresponds the at least one touch point as magnified to the character key as magnified; and
an input component that receives input via a text box of the user interface, wherein the input comprises a character assigned to the character key in response to touch activation of the character key as magnified.

2. The system of claim 1, wherein the device-executable components further comprise a grouping component that groups the character key with the at least one neighboring character key determined to be adjacent to the character key to generate the character key group comprising the character key and the at least one neighboring character key.

3. The system of claim 2, wherein the grouping component increases or decreases the integer number of character keys comprising the character key group.

4. The system of claim 1, wherein the device-executable components further comprise a zooming component that enlarges the character key group as magnified and discontinues displaying at least one unmagnified character key associated with the virtual keyboard.

5. The system of claim 1, wherein the device-executable components further comprise a scrolling component that scrolls over character key groups to magnify the character key group via touch activation of the character key group via virtual directional touch arrows.

6. The system of claim 5, wherein the scrolling component employs a swiping component that scrolls over the character key groups to magnify the character key group via touch swiping input received by the virtual keyboard.

7. The system of claim 1, wherein the device-executable components further comprise a reversion component that reverts the character key group as magnified to a standard virtual keyboard display.

8. The system of claim 1, wherein the device-executable components further comprise a separation component that displays the character key group as magnified at a separate region of the user interface without interfering with display of the virtual keyboard.

9. The system of claim 1, wherein the device-executable components further comprise a correction component that labels with a symbol a touch point corresponding to a most recent character input entered into the text box.

10. The system of claim 8, wherein the correction component labels the touch point or the touch point as magnified by at least one of a differentiated color, character key background, character key shape, character key shading, or character key font.

11. The system of claim 1, wherein magnifying component magnifies an individual character key or the character key group at least one of diagonally, multi-dimensionally, horizontally, or vertically.

12. The system of claim 1, wherein the device-executable components further comprising a contrasting component that contrasts one or more magnified character keys belonging to the character key group as magnified with one or more unmagnified character keys by at least one of analysis of differentiation of font, character key background variation, character key color, or character key shape of the one or more magnified characters relative to the one or more unmagnified character keys.

13. The system of claim 1, wherein the device-executable components further comprise a learning component that determines the integer number of character keys or constituency of individual character keys that comprise the character key group based at least on historical data.

14. The system of claim 1, wherein the device-executable components further comprise a shaping component that displays one or more character keys or magnified character keys according to at least one of a different size, or shape.

15. A method comprising:
facilitating, by a system comprising a processing device, presentation of a virtual keyboard by a user interface of the system, wherein the virtual keyboard comprises an integer number of character keys;
associating at least one touch point of the user interface to a character key group comprising a character key and at least one neighboring character key that is adjacent to the character key;
magnifying the character key group associated with the at least one touch point in response to touch activation of the at least one touch point;
corresponding at least one magnified touch point of the user interface to a magnified character key, wherein the at least one magnified touch point is a magnified version of the at least one touch point and the magnified character key is a magnified version of the character key; and
via a text box of the user interface, receiving input comprising a character assigned to the character key in response to touch activation of the magnified character key.

16. The method of claim 15, further comprising grouping the character key with the at least one neighboring character key determined to be adjacent to the character key to generate the character key group comprising the character key and the at least one neighboring character key.

17. The method of claim 16, further comprising increasing or decreasing the integer number of character keys comprising the character key group.

18. The method of claim 15, further comprising enlarging the magnified character key group and discontinuing displaying at least one unmagnified character key associated with the virtual keyboard.

19. The method of claim 15, further comprising scrolling over character key groups to magnify the character key group via touch activation of virtual directional touch arrows.

20. The method of claim 18, further employing swiping that scrolls over the character key groups to magnify the character group via touch swiping received by the system.

21. The method of claim 15, further comprising reverting the magnified character key group to a standard virtual keyboard display.

22. The method of claim 15, further comprising displaying the magnified character key group at a separate region of the user interface without interfering with display of the virtual keyboard.

23. The method of claim 22, further comprising labeling a touch point or magnified touch point by at least one of a differentiated color, no variation of color with a differentiated character key background variation, or no variation of color with a different character key shape.

24. The method of claim 15, further comprising labeling with a symbol a touch point corresponding to a most recent character input entered into the text box.

25. The method of claim 15, further comprising magnifying either an individual character key or the character key group at least one of diagonally, multi-dimensionally, horizontally, or vertically.

26. The method of claim 15, further comprising contrasting one or more magnified character keys of the magnified character key group with one or more unmagnified character keys by at least one of differentiation of font, character key background variation, character key color, or character key shape.

27. The method of claim 15, further comprising determining the integer number of character keys or constituency of individual character keys that comprise the character key group based at least on historical data.

28. The method of claim 15, further comprising displaying one or more character keys or magnified character keys with a different size, or shape.
